(19) United States
(12) Patent Application Publication
(10) Pub. No.: US 2011/0206818 A1
(43) Pub. Date: Aug. 25, 2011

(54) Solar Oven and Method of Solar Cooking

(76) Inventor: Arlus Walters, Stillwell, OK (US)

(21) Appl. No.: 12/709,183

(22) Filed: Feb. 19, 2010

(51) Int. Cl. F24J 2/44; F24J 2/02; A47J 37/00; A23L 1/01

(52) U.S. Cl. 426/523; 126/681; 126/638; 99/467; 126/714

(57) ABSTRACT

An improved solar oven with the ability to overcome recognized prior art limitations, such as temperature variation during prolonged cloudy periods is described. The solar oven according to the invention utilizes an enclosure similar to a box type oven and a thermosiphon (alt. thermosyphon) device to generate and maintain heat sufficient to cook food. The invention also encompasses a method of solar cooking utilizing an enclosure similar to a box type oven and a thermosiphon device.

### FIELD OF THE INVENTION

The present invention pertains to a device and method for capturing solar energy for use in preparing consumables (e.g., food, water) for consumption.

The use of solar energy to cook food is not new. Solar ovens and cookers are well known in the marketplace and are used in a wide variety of circumstances. The two largest markets for solar cookers are for recreational purposes and for use in impoverished areas where fuels for cooking and pasteurizing safe drinking water are scarce or non-existent.

The three most common types of solar cookers are heat trap boxes, curved concentrators (parabolic), and panel cookers. Heat trap boxes are based on the greenhouse effect. The box has at least one transparent face (glass or plastic) oriented toward the sun. Solar radiation passes through the transparent face where a portion of it is absorbed by materials inside the box (e.g., dark pots or a dark absorber plate) and is converted into longer wavelength infrared energy. Most of this infrared energy cannot pass back out through the glass and is therefore trapped within the enclosed space. Over time the temperature inside the box to rises to a temperature sufficient to cook food. Some designs include a reflective device to increase the amount of solar radiation directed through the transparent cover of the box.

Curved concentrator cookers (also known as “parabolics”) utilize reflective parabolic dishes to highly concentrate solar radiation at a focal point. Cooking vessels placed at the focal point can reach very high temperatures very quickly. These types of cookers are often used in remote areas to cook food, purify drinking water, or generate steam. One disadvantage to these types of cookers is that they can be dangerous to uneducated users.

Panel cookers incorporate elements of box and curved concentrator cookers. Usually they resemble a box having a malleable reflective screen surrounding it. They are simple and relatively inexpensive to buy or produce. These types of cookers are likely the most common form of solar cooker used.

All three of the known forms of solar cooking devices exhibit various design flaws or problems. For example, the curved concentrator cookers and the panel cookers require elaborate reflectors. In the case of the curved concentrator versions, these reflectors concentrate so much heat and UV radiation that they can be dangerous to use. The reflectors in a panel cooker are often unwieldy or flimsy and prone to damage. The known box type cookers, such as the SOS Sport Oven available at www.solarovens.org, as well as the reflective cookers tend to be quite susceptible to temperature variations during use from passing clouds. Temperature variations can lead to undercooked food, unpasteurized water, and disease transmission

### OBJECT AND SUMMARY OF THE INVENTION

In view of the above, it is an object of the present invention, among others, to provide a solar cooker that does not require the use of dangerous, unwieldy, or easily damaged reflectors.

It is another object of the present invention to provide a solar cooker that is not as susceptible to cloud induced temperature fluctuations as are known solar cookers.

It is another object of the invention to provide a solar cooker that is safe to use.

It is a still further object of the invention to provide a method of cooking with solar energy that is efficient and provides safe food.

Briefly, and in general terms using exemplary language to aid but not limit the discussion, the above objects are met by the present invention which is directed to a solar oven that utilizes a thermosiphon device to capture and regulate heat within an enclosed space.

In its most basic form, the invention is a solar oven having a housing and a cover panel where the cover is transparent to solar radiation. A thermosiphon device to capture and regulate the heat within the enclosure rests within the enclosed space. A door attached to the housing allows a user to place consumable items within the enclosure where it is prepared.

The invention also encompasses a method of using solar energy for preparing consumables. The method according to the invention utilizes the steps of positioning a thermosiphon device to absorb heat in the form of solar radiation in one portion of an enclosure. The thermosiphon device absorbs the heat and transfers a portion of the heat to a second portion of the enclosure thereby raising the temperature within the second portion of the enclosure to a temperature sufficient to prepare a consumable.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is a perspective transparent view of the device according to the invention.

FIG. 2 is a perspective view of the device according to the invention with the thermosiphon device removed.

FIG. 3 is a rear view of the device according to the invention.

FIG. 4 is a side view of the device according to the invention.

FIG. 5 is a frontal view of the device according to the invention.

### DETAILED DESCRIPTION

The present invention will now be described more fully hereinafter with reference to the accompanying drawings, in which a preferred embodiment of the invention is shown. However, this invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

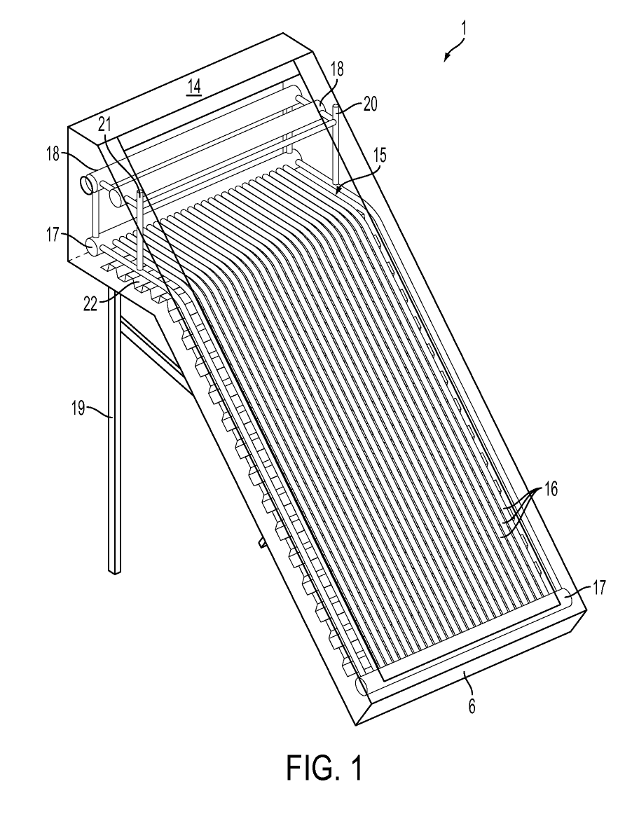

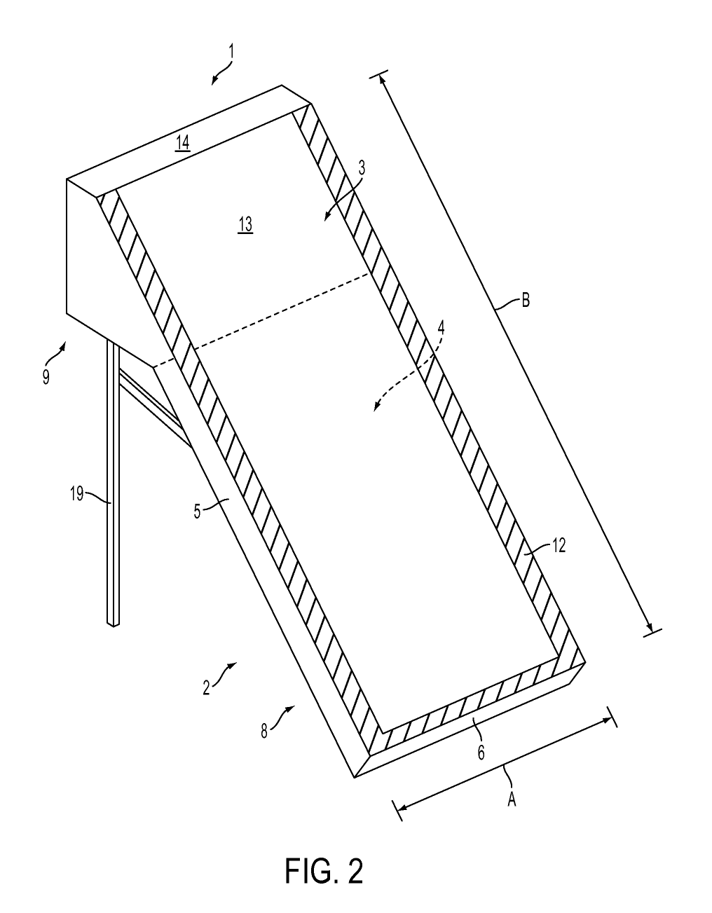

One embodiment of the invention is a solar oven 1 that utilizes trapped solar radiation to increase the temperature inside an enclosed space to a level sufficient to prepare a consumable (i.e., cook food, pasteurize water, etc.). A preferred and exemplary embodiment of the invention is shown in FIGS. 1 and 2, to which we now turn.

The solar oven 1 according to the invention comprises a housing 2 and a cover panel 3. The housing 2 and the cover panel 3 combine to aid in defining an enclosed space 4. The housing 2 comprises two side panels 5, two end panels 6, and a bottom 7 to form an open-top, box-like structure. In preferred embodiments such as the one shown in FIGS. 1 and 2, the side panels 5 are generally longer than the end panels 6 to form a rectangular shaped box. The embodiment shown in FIGS. 1 and 2 utilizes a top panel 14 adjacent the cover panel 3 to complete the housing 2 and make the geometry of the enclosure more box-like at one end. This is a design choice that may be altered by the practitioner as discussed supra.

The housing 2 may be made from any suitable material. For example, prototypes of the invention utilized side panels 5, end panels 6, and a bottom 7 made from sheet metal. Side panels 5, end panels 6, and bottom 7 may also be made out of composite materials such as layered and insulated metal/glass/ceramic structures which can reduce undesirable heat transfer between the interior of the oven and the outside environment. Those skilled in the art of solar oven construction will readily adapt current and future construction materials to make side panels 5, end panels 6, and bottom 7 that best fit their particular needs.

The cover panel 3 is transparent to solar radiation and is attached to the housing in a manner such that it both forms the “lid” to the box (thereby defining the enclosed space 4) and allows passage of solar radiation into the enclosed space 4. The cover panel 3 may be made from any material that is transparent to solar radiation and is capable of withstanding the temperatures generated during practice of the invention. Such materials include glass and heat resistant polymers.

The architecture of the cover panel 3 may vary considerably. For example, the cover panel 3 may be completely transparent across the width (A) and the length (B) of the housing 2. Alternatively, the cover panel 3 may incorporate non-transparent panels 12 that shield or shade a portion of the enclosed space 4 from solar radiation. The relevance of shielding a portion of the enclosed space 4 from solar radiation is discussed in subsequent paragraphs.

The cover panel 3 could be as simple as a single pane of glass or it could be made of multiple panes of insulated and sealed glass similar to high efficiency windows in LEED certified homes. Those skilled in the art will readily grasp the engineering tradeoffs that must be made when choosing the design of the cover panel 3. Cost of manufacture, market price, and functionality will determine the complexity of the ultimate design. Those skilled in the art are quite capable of making the slight engineering adjustments necessary to tailor a particular cover panel 3 to their particular needs.

The cover panel 3 may be attached to the housing 2 using any of the means currently utilized to attach or otherwise incorporate transparent cover panels in current box-type solar cooker designs. In the prototype of the invention a double paned, insulated glass door was used as a cover panel 3 and was seated into a slight recess formed at the top of the side panels 5, the lower end panel 6 and the top panel 14. The cover panel was sealed into position using a high temperature sealant and riveted to the side panels 5 and end panel 6.

Since an object of the invention is to provide an oven capable of cooking food, the device according to the invention should provide an enclosed oven area 13 to cook food.

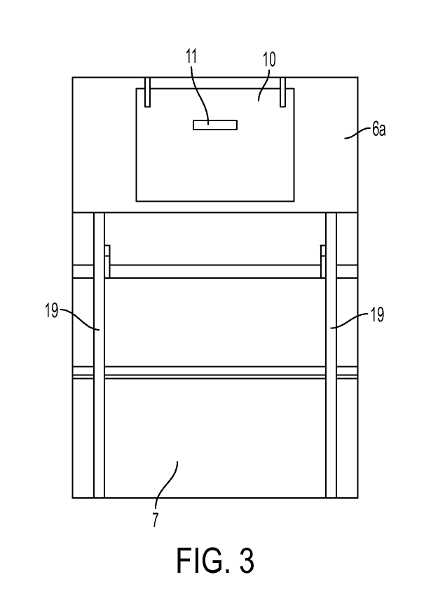

The enclosed oven area 13 is formed by the geometry of the housing 2 which is determined, at least in part, by the geometry of the side panels 5, the end panels 6, and the bottom 7. Turning now to FIGS. 2, 3, and 4, the housing 2 may be generally considered to have two ends, a first end 8 and a second end 9 defined by an approximately 22.5 degree bend, C, in the bottom 7. As can be seen from the Figures, the enclosed oven area 13 is located in the second end 9 of the housing 2.

The enclosed oven area 13 is provided by enlarging the portion of the side panels 5 associated with the second end 9 of the housing 2 relative to the portion of the side panels 5 associated with the first end 8 of the housing 2. The 22.5 degree bend, C, in the bottom 7 of the housing 2 in conjunction with the increased height of the end panel 6a associated with the second end 9 of the housing 2 and the enlarged portions of the side panels 5, help define an enclosed oven area 13 of sufficient size to receive consumables (e.g, food, water).

The exact dimensions of the enclosed oven area 13 will vary with the panel geometry chosen by the practitioner. For example, in a preferred embodiment shown in the drawings the enclosed oven area 13 is in the general shape of a right angle trapezoid due to the presence of a flat top panel 14 placed intermediate the cover panel 3 and the end panel 6a associated with the second end 9 of the housing 2. This top panel 14 provides a more box like shape to the enclosed oven area 13. However, an alternative construction could simply remove the top panel 14 and extend the length of cover panel 3 such that it attaches to the end panel 6a associated with the second end 9 of the housing 2. This would result in a more triangular shaped enclosed oven area 13. As will be discussed in more detail below, the dimensions of the enclosed oven area 13 (particularly the height of the end panel 6a) should be sufficient to allow room for a portion of a thermosiphon device and the consumable.

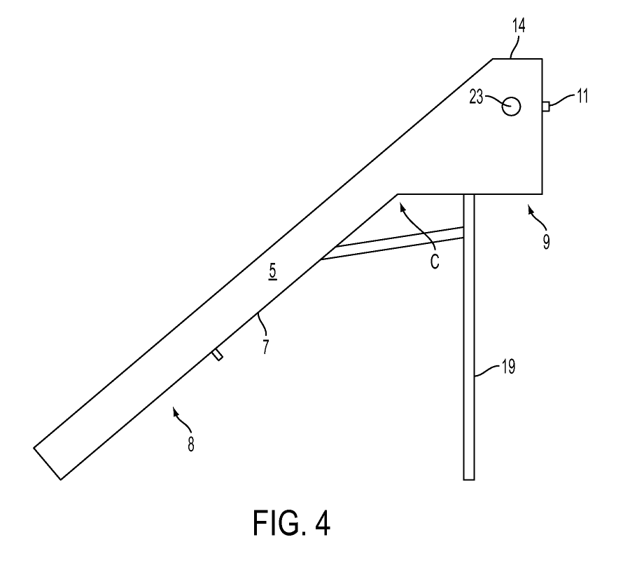

A door 10 with a handle 11 is positioned somewhere in the second end 9 of the housing 2 to allow communication with the enclosed oven area 13 and the placement of a consumable in the enclosed oven area 13. The door 10 may be attached or otherwise incorporated into a side panel 5 or the end panel 6a. The door 10 may be attached to the housing 2 using any traditional means for attachment such as a hinge similar to those used with traditional oven doors or it may be slidably mounted such as those sometimes found on BBQ smokers. The door 10 and all other components of the device 15 should be attached to one another in such a manner to seal the enclosed space 4 and particularly the enclosed oven area 13 sufficiently to allow for the retention of heat within the device. This may be accomplished using sealing methods currently incorporated into known box-type cookers. A temperature indicator 23, schematically represented in FIG. 4, should also be incorporated into the design of the device according to the invention for safety purposes. There are many types of temperature indicators commercially available and those skilled in the art will choose the type most suitable for their particular design.

The device according to the invention also comprises a thermosiphon device. Thermosiphon (alt. thermosyphon) refers to a method of passive heat exchange based on natural convection which circulates liquid without the necessity of a mechanical pump. This circulation can either be open-loop, as when liquid in a holding tank is passed to a distribution point; or it can be a closed-loop circuit. Its intended purpose is to simplify the pumping of liquid and/or heat transfer by avoiding the cost and complexity of a conventional liquid pump.

Convective movement of the liquid starts when liquid in the loop is heated, causing it to expand and become less dense, and thus more buoyant than the cooler liquid in the bottom of the loop. Convection moves heated liquid upwards in the system as it is simultaneously replaced by cooler liquid returning by gravity. Ideally, the liquid flows easily because a good thermosiphon should have very little hydraulic resistance.

The device according to the invention incorporates the principle of thermosiphon heat transfer to improve the performance of heat box type solar ovens by increasing the achievable temperatures and moderating temperature swings within the oven enclosure. The device increases temperatures by trapping heat within a heat absorbing liquid which adds to the heat created by the greenhouse effect. The thermosiphon device moderates temperature swings within the oven enclosure, specifically temperature swings caused by passing clouds, due to the continued circulation of heated fluid and the transfer of heat to the enclosed oven area 13 while clouds pass. A prototype of the invention consistently generated and maintained temperatures around 121 degrees Celsius (250 F) on partly cloudy days when the ambient temperature was below freezing.

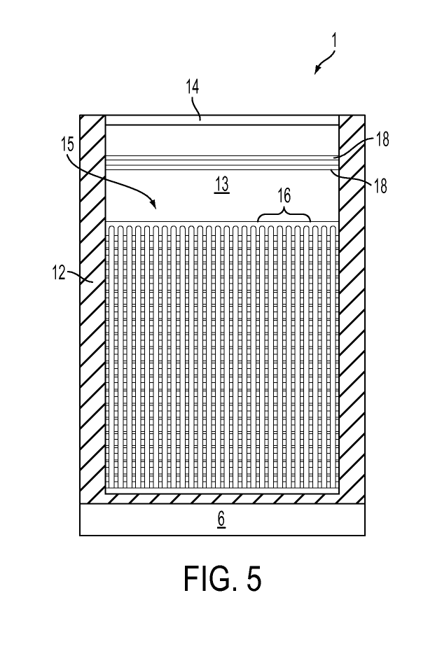

Turning to FIGS. 1 and 5, the thermosiphon device 15 utilized in the practice of the invention comprises a plurality of thermosiphon tubes 16 in fluid communication with one another via at least two manifolds 17 where one manifold is situated lower than the other and the thermosiphon tubes 16 are positioned intermediate the manifolds 17.

The thermosiphon device 15 is situated within the enclosed space 4 formed by the housing 2 and the cover panel 3 as shown in FIG. 1. In a preferred embodiment, the thermosiphon tubes 16 and thus the thermosiphon device 15 extend from the first end 8 of the housing 2 to the second end 9 of the housing 2. The thermosiphon tubes 16 are connected to a manifold 17 near the bottom of the first end 8 of the housing 2. The thermosiphon tubes 16 are likewise connected to a manifold 17 at the second end 9 of the housing 2. In a preferred embodiment, the plurality of thermosiphon tubes 16 extend along the bottom 7 of the enclosed oven area 13 and terminate in a manifold 17 proximate the end panel 6a of the second end 9 of the housing 2. In the design shown in FIG. 1 the thermosiphon tubes 16 extending along the bottom of the enclosed oven area 13 also function as a rack upon which food or other consumables may sit while they cook.

The thermosiphon device 15 also comprises an opening to fill the tubes with a fluid capable of absorbing heat. Such an opening is shown as a “fill tube” 20 in FIG. 1. Similarly, the thermosiphon device 15 preferably comprises an opening or vent 21 that provides pressure relief for the system. Both the “fill tube” 20 and the vent 21 may be securely closed which may be advantageous depending on the fluid used in the system. If the vent 21 is closed it is recommended that a pop-off valve (not shown) be incorporated into the design as a safety precaution.

The location of the fill tube 20 and the vent 20 is also subject to designer's preference. A prototype of the device according to the invention had both the fill tube 20 and the vent 21 located within the enclosed oven area 13. The fill tube 20 and/or the vent 21 could just as easily be located outside of the enclosed oven area 13 and/or housing 2. The main factors for determination for location is probably the type of fluid used within the system (i.e., would the fluid contaminate consumables if spilled in the oven area), ease of use, and safety considerations (i.e., venting hot fluid out of the device onto a user).

One or more expansion tubes 18 are preferably incorporated into the thermosiphon device 15 to provide space for expanding fluid volume. FIG. 1 shows two expansion tubes 18 placed above the upper manifold 17. Again, the number of expansion tubes 18 and their exact placement is designer's choice. The use of one expansion tube 18 or several small ones could work just as well as the design shown in FIG. 1.

The thermosiphon device 15 should also include a drain (not shown) that allows a user to flush the system in the event it becomes clogged over time (as when a user may fill the device with a dirty fluid). Preferably the drain is associated with the lower manifold 17 but its exact placement may be chosen by the practitioner.

The material utilized in the construction of the thermosiphon device 15 may be any material capable of handling the temperature and pressures inherent in the system. Metal tubing is anticipated to be the most economical material at this time and was used in making a prototype of the invention. Metal tubing absorbs heat well and its use in thermosiphon construction is well established. Furthermore, the use of metal tubing would be indicated if one desired to build a closed system. However, care would need to taken regarding the choice of heat absorbing fluid and testing the pressure capabilities of the system if a closed system is utilized. It is anticipated that tubes made of other materials such as ceramics or specialized glass or polymers may be incorporated into the practice of the invention at some point depending on cost and engineering considerations.

The fluid utilized to fill the thermosiphon device 15 may be any fluid capable of absorbing heat and initiating the natural convection movement necessary for a functioning thermosiphon device. The fluids used in the practice of the invention can vary from hydrocarbons (i.e., mineral oil) to ordinary water. A prototype of the invention utilized food grade mineral oil because of its high boiling point, low cost, and performance in the system. Other petroleum based heat transfer fluids and/or natural oil based fluids (i.e., plant oils) may also be used as the heat transfer fluid in the practice of the invention.

It is anticipated that an end user may attempt to use water as a fluid for the thermosiphon device 15. It should be noted that the use of water adds an additional level of complexity to the design for safety reasons. Temperatures within the device according to the invention may readily reach or exceed 100 degrees C. which will turn the water to steam. If an open system is used this may result in boiling water escaping the system (as happened during testing of a prototype) and injuring a user. If a closed system is used, the steam may generate pressures sufficient to violently rupture a tube or a manifold causing injury. Accordingly, water is not recommended for use in the practice of the invention unless additional safety engineering and stronger materials are incorporated into the design of the invention.

A natural thermosiphon system generally requires two gradients to function. One is a gravitational gradient. The other is a temperature gradient.

The gravitational gradient is provided by elevating one end of the device according to the invention with respect to the other end. In the embodiment shown in the drawings, the second end 9 of the housing 2 is elevated with respect to the first end 8 and is supported by legs 19. It should be noted that the length of the housing 2 and the degree of bend in the housing 2 can vary depending upon usage. For example, a device built according to the invention that is used at the equator might not require a bottom with a bend of 22.5 degrees to function adequately.

The temperature gradient is provided by shielding or shading a portion of the thermosiphon device 15 from direct solar radiation by placing a non-transparent panel 12 intermediate a portion of the thermosiphon device 15 and the sun. This shielding or shading may be accomplished in numerous ways.

A prototype of the invention shielded a portion of the thermosiphon device 15 by enclosing two thermosiphon tubes 16 proximate both side panels 5 along with the entire manifold 17 in the first (lower) portion 8 of the housing 2 in a metal box schematically represented by the non-transparent panel 12 shown in FIG. 2. Alternatively, the cover panel 3 could incorporate non-transparent shielding (e.g., metal, reflective paint) along its borders as schematically shown in FIG. 2 to accomplish the same task. The idea is that there exists some structure having the capability of lowering the temperature of at least a portion of the fluid with the thermosiphon device 15. Many other variations of providing the requisite shielding and/or temperature gradient exist and are within the knowledge of those skilled in the art.

The temperature gradient provides the “engine” by which the thermosiphon system operates. Solar energy passes through the cover panel 3 and contacts the thermosiphon tubes 16 where it is absorbed as heat. This heat is transferred to the heat absorbing fluid within the tubes (e.g., mineral oil in the prototype device). The fluid expands as it heats and thus becomes less dense.

Concurrently with the heating of the fluid in the tubes exposed to solar radiation, the fluid contained in the portion of the device shielded from the sun (or otherwise cooled) becomes cool. As the fluid cools it becomes denser. The force of gravity causes this denser fluid to flow toward the manifold 17 in the first (lower) end 8 of the housing 2. This downward movement of the cooler fluid forces the upward flow of the hotter, less dense fluid, which in turn eventually forces more fluid into the shaded/cooled regions thus completing the cycle of heat transfer.

Returning to FIG. 1, a preferred embodiment of the device according to the invention incorporates additional heat absorbing materials within the enclosed space 4 defined by the housing 2 and the cover panel 3. The additional heat absorbing material increases the conversion of solar energy to heat thus making the device more efficient. In a prototype of the invention and as shown in FIG. 1, a heat absorbing support structure 22 is inserted intermediate the bottom 7 of the housing 2 and the thermosiphon device 15.

The heat absorbing support structure 22 may be any material that can absorb heat and withstand the temperatures necessary for operation of the device. In the prototype of the device according to the invention the heat absorbing structure was a sheet of corrugated metal painted black and bent at the same angle as the bottom 7 of the housing 2. The heat absorbing support structure was attached to the housing rivets but any suitable type of attaching means may be used (e.g., spot welding).

Likewise, the thermosiphon device 15 may be attached using any suitable means. Clamping the device to the sides and/or bottom of the housing 2 may facilitate easy removal of the device for repair but other more permanent means of attachment such as spot welding to the housing 2 or heat absorbing support structure 22 may be used.

The invention also comprises a method of preparing consumables utilizing solar energy utilizing a device similar to the one described above. The description of the device according to the invention is incorporated by reference in this discussion of the method according to the invention.

The method according to the invention comprises the steps of positioning a thermosiphon device 15 to absorb heat in the form of solar radiation in one portion of an enclosed space 4. The operation of the thermosiphon device 15, in conjunction with the “greenhouse effect” associated with solar energy passing through the cover panel 3, transfers heat energy to a second portion of the enclosed space 4 thereby raising the temperature within the second portion of the enclosure 4 (e.g., the enclosed oven area 13) to a temperature sufficient to prepare a consumable.

More specifically, in the method according to the invention, the step of transferring heat comprises placing a fluid capable of absorbing and transporting heat within a thermosiphon device 15 and creating conditions within the enclosed space 4 sufficient to generate convection driven fluid flow and heat transfer. Such conditions may be created by elevating on portion of the enclosure 4 relative to another portion of the enclosure 4 and shielding at least a portion of the thermosiphon device 15, such as one or more thermosiphon tubes 16, from receiving direct contact from solar radiation.

The method according to the invention also encompasses placing a consumable (e.g., food, water, etc.) within the second portion of the enclosure (e.g., enclosed oven area 13) at a temperature and for a time sufficient to prepare the consumable for consumption. As noted previously, a prototype of the device has consistently generated temperatures of 121 C (250 F) on partly cloudy days with ambient temperatures at or below 0 C (32 F).

As will be apparent to those skilled in the art, various changes and modifications may be made to the device and method of the present invention without departing from the spirit and scope of the invention as determined in the appended claims and their legal equivalent.

In the drawings and specification, there have been disclosed typical embodiments on the invention and, although specific terms have been employed, they have been used in a generic and descriptive sense only and not for purposes of limitation, the scope of the invention being set forth in the following claims.

1. A solar oven comprising:
a housing and a cover panel, said cover panel being transparent to solar radiation, said housing and cover panel defining an enclosed space;
a thermosiphon device within said defined enclosed space; and
a door allowing communication with said enclosure.

2. A solar oven according to claim 1 wherein said housing comprises a bottom opposite said cover, and a first end and a second end; said door attached to said second end of said housing allowing communication with said enclosure.

3. A solar oven according to claim 1 wherein said thermosiphon device comprises a plurality of tubes in fluid communication with each other via at least two manifolds.

4. A solar oven according to claim 3 further comprising at least one non-transparent panel positioned to shield at least a portion of said thermosiphon device from direct solar radiation.

5. A solar oven according to claim 2 wherein said thermosiphon device comprises
(a) a plurality of tubes extending from said first end of said housing to said second end of said housing,
(b) a first manifold connecting said tubes at said first end of said housing,
(c) a second manifold connecting said tubes at said second end of said housing,
(d) expansion tubing to accommodate expansion of a fluid capable of absorbing heat,
(e) a vent to relieve pressure in said thermosiphon device, and
(f) an opening to fill said tubes with a fluid capable of absorbing heat.

6. A solar oven according to claim 2 wherein said second end of said housing is elevated with respect to said first end of said housing.

7. A solar oven according to claim 2 wherein said second end of said housing and said cover aid in defining an enclosed cooking area that is accessible via said door and is of sufficient size to receive a quantity of consumables.

8. A solar oven according to claim 2 further comprising a heat absorbing support structure positioned intermediate said thermosiphon array and said bottom of said housing.

9. A solar oven according to claim 1 wherein said cover is selected from the group consisting of glass and polymers.

10. A solar oven according to claim 3 wherein said tubes contain a fluid capable of absorbing heat.

11. A solar oven comprising:
(a) an enclosure, said enclosure defined by
a housing wherein said housing comprises a bottom, and a first end and a second end, said first and second ends being in fluid communication with each other; and
a cover panel transparent to solar radiation, said cover panel positioned opposite said bottom of said housing;
(b) a thermosiphon array within said enclosure, said thermosiphon array comprising a plurality of tubes in fluid communication with each other via at least one manifold, said tubes containing a fluid capable of absorbing heat;
(c) at least one non-transparent panel positioned to shield at least a portion of said thermosiphon array from direct solar radiation; and
(d) a door attached to said housing allowing communication with said enclosure.

12. A method of preparing consumables utilizing solar energy, the method comprising the steps of:
positioning a thermosiphon device to absorb heat in the form of solar radiation in one portion of an enclosure;
transferring the absorbed heat to a second portion of the enclosure via the thermosiphon device thereby raising the temperature within the second portion of the enclosure to a temperature sufficient to prepare a consumable.

13. The method according to claim 12 wherein the thermosiphon device comprises a plurality of tubes in fluid communication with each other via at least one manifold.

14. The method according to claim 12 where the enclosure has a cover panel that is transparent to solar radiation.

15. The method according to claim 14 wherein the enclosure is sealed to an extent sufficient to retain heat within the enclosure.

16. The method according to claim 13 wherein the step of transferring the heat comprises placing a fluid capable of absorbing and transporting heat within the tubes of the thermosiphon device and creating conditions within the enclosure sufficient for convection driven fluid flow.

17. The method according to claim 16 wherein the step of creating conditions within the enclosure sufficient for convection driven fluid flow comprises shielding at least a portion of the thermosiphon device from direct solar radiation.

18. The method according to claim 17 wherein the step of creating conditions further comprises the step of elevating the second portion of the enclosure relative to the first portion of the enclosure.

19. The method according to claim 12 further comprising the step of placing food within the second portion of the enclosure for a time sufficient to prepare the consumable.
